(19) United States
(12) Patent Application Publication
(10) Pub. No.: US 2023/0004830 A1
(43) Pub. Date: Jan. 5, 2023

(54) AI-Based Cognitive Cloud Service

(71) Applicant: Oracle International Corporation, Redwood Shores, CA (US)

(72) Inventor: Orlando AREVALO, Hurth (DE)

(21) Appl. No.: 17/363,248

(22) Filed: Jun. 30, 2021

(51) Int. Cl. G06N 5/04; G06N 20/00; G06F 40/40

(52) U.S. Cl. CPC G06N 5/04; G06N 20/00; G06F 40/40

(57) ABSTRACT

Embodiments provide cognitive cloud services. Embodiments receive, via an input Application Programming Interface (“API”), input data, the input data including one or more of text data, picture data, audio data and video data. Embodiments determine one or more formats of the input data and, based on the determined formats, select one or more of artificial intelligence based modules for processing of the input data. Embodiments collect an output resulting from the processing of the input data and enrich the output. Embodiments then provide the enriched output via an output API.

### FIELD

One embodiment is directed generally to artificial intelligence, and in particular to an artificial intelligence-based cognitive cloud service.

### BACKGROUND INFORMATION

Cognitive computing or cognitive services refers to technology platforms that are generally based on the scientific disciplines of artificial intelligence and signal processing. These platforms encompass machine learning, reasoning, natural language processing, speech recognition and vision (i.e., object recognition), human-computer interaction, dialog and narrative generation, among other technologies.

Further, cognitive computing has been used to refer to new hardware and/or software that mimics the functioning of the human brain and helps to improve human decision-making. In this sense, cognitive computing is a new type of computing with the goal of more accurate models of how the human brain/mind senses, reasons, and responds to stimulus.

Cognitive computing systems/services may be adaptive, in that they may learn as information changes, and as goals and requirements evolve, they may resolve ambiguity and tolerate unpredictability, and they may be engineered to feed on dynamic data in real time, or near real time. Cognitive computing systems/services may be interactive in that they may interact easily with users so that those users can define their needs comfortably, and they may also interact with other processors, devices, and cloud services, as well as with people.

Cognitive computing systems/services may be iterative and stateful in that they may aid in defining a problem by asking questions or finding additional source input if a problem statement is ambiguous or incomplete, and they may “remember” previous interactions in a process and return information that is suitable for the specific application at that point in time. Cognitive computing systems/services may be contextual in that they may understand, identify, and extract contextual elements such as meaning, syntax, time, location, appropriate domain, regulations, user's profile, process, task and goal. They may draw on multiple sources of information, including both structured and unstructured digital information, as well as sensory inputs (visual, gestural, auditory, or sensor-provided).

### SUMMARY

Embodiments provide cognitive cloud services. Embodiments receive, via an input Application Programming Interface (“API”), input data, the input data including one or more of text data, picture data, audio data and video data. Embodiments determine one or more formats of the input data and, based on the determined formats, select one or more of artificial intelligence based modules for processing of the input data. Embodiments collect an output resulting from the processing of the input data and enrich the output. Embodiments then provide the enriched output via an output API.

### BRIEF DESCRIPTION OF THE DRAWINGS

FIG. 1 is an overview diagram of elements of an AI based cognitive cloud service/system that can implement embodiments of the invention.

FIG. 2 is a block diagram of one or more components of system of FIG. 1 in the form of a computer server/system in accordance with an embodiment of the present invention.

FIG. 3 is a high level diagram of the functionality of the system of FIG. 1 in accordance to embodiments.

FIG. 4 is a flow diagram of the functionality of the AI cognitive cloud service module of FIG. 1 for performing AI cognitive cloud services in accordance with one embodiment.

FIG. 5 illustrates an example input to demonstrate unexpected results of embodiments of the invention.

### DETAILED DESCRIPTION

One embodiment is an integrated artificial intelligence (“AI”) based cognitive system/service that provides cognitive analysis of audio and video based sources and generates an enriched file based on the cognitive analysis.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

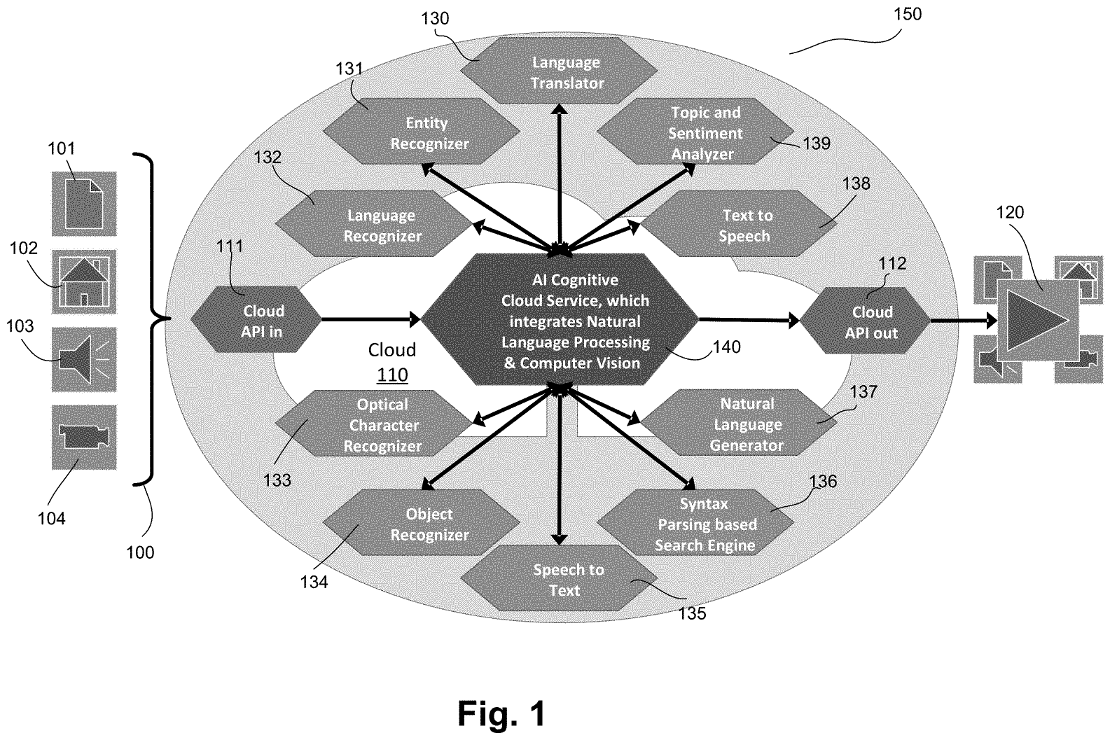

FIG. 1 is an overview diagram of elements of an AI based cognitive cloud service/system 150 that can implement embodiments of the invention. In general, system 150 is a cloud based AI service available via an Application Programming Interface (“API”) call. System 150 provides an integrated cognitive analysis of audio and video files as well as streams, and include the following functionalities: (1) audio to text translation; (2) language recognition; (3) object detection, recognition and classification; (4) scene description (e.g., natural language generation based on what is happening in the video); (5) text to audio translation (e.g., reading texts on pictures or scenes); (6) entity recognition and classification; (7) audio and text anonymization based on a given entity based filtering (e.g., bleep out all names of persons); (8) content search based on semantic and syntactic queries (e.g., “find scenes when a person crosses a street and phones at the same time”); and (9) any further capabilities to produce a machine based understanding and analysis of audio and video content.

System 150 is implemented on a cloud 110 so that it functions as a Software as a service (“SaaS”). Cloud computing in general is the on-demand availability of computer system resources, especially data storage (cloud storage) and computing power, without direct active management by the user. In one embodiment, cloud 110 is implemented by the Oracle Cloud Infrastructure (“OCI”) by Oracle Corp.

System 150 receives, as input data 100, text data 101, picture data 102, audio data 103 and/or video data 104. Input data 100 can be on-demand or live streamed. Subsequently, system 150 outputs an enriched file 120. Enriched file 120 is structured to provide information as if a person would have analyzed all the inputs and provided a detailed description of what the entire input content conveys.

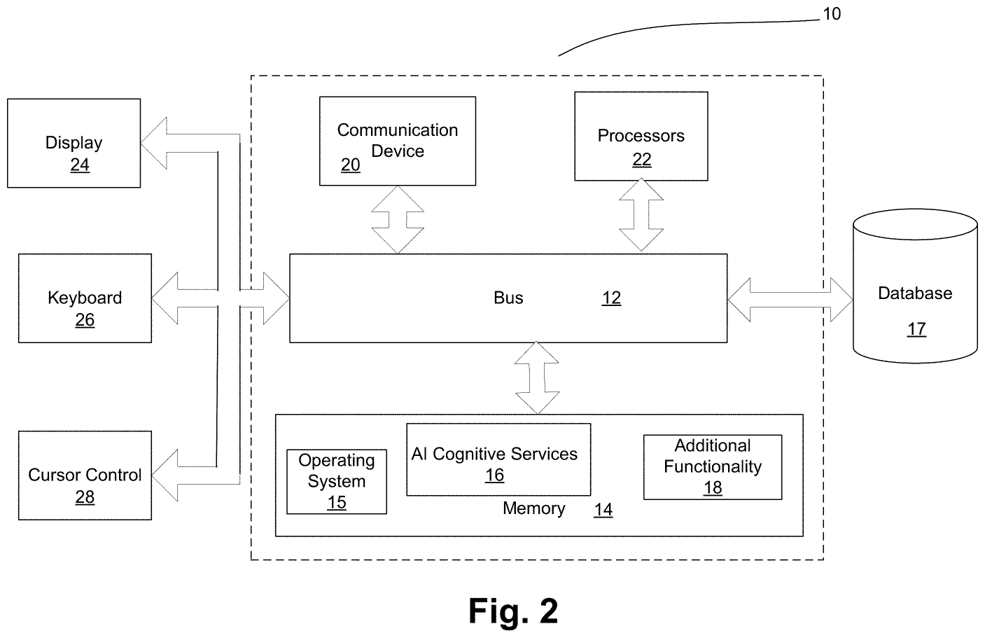

FIG. 2 is a block diagram of one or more components of system 150 of FIG. 1 in the form of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. System 10 can be used to implement any of the components/elements shown in FIG. 1 and/or interact with any of the components.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”) and includes a microphone for receiving user utterances. A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an AI cognitive services module 16 that implements AI cognitive services, and all other functionality disclosed herein. System 10 can be part of a larger system. Therefore, system 10 can include one or more additional functional modules 18 to include the additional functionality. A file storage device or database 17 is coupled to bus 12 to provide centralized storage for modules 16 and 18. In one embodiment, database 17 is a relational database management system (“RDBMS”) that can use Structured Query Language (“SQL”) to manage the stored data.

In one embodiment, particularly when there are a large number of distributed files at a single device, database 17 is implemented as an in-memory database (“IMDB”). An IMDB is a database management system that primarily relies on main memory for computer data storage. It is contrasted with database management systems that employ a disk storage mechanism. Main memory databases are faster than disk-optimized databases because disk access is slower than memory access, the internal optimization algorithms are simpler and execute fewer CPU instructions. Accessing data in memory eliminates seek time when querying the data, which provides faster and more predictable performance than disk.

In one embodiment, database 17, when implemented as an IMDB, is implemented based on a distributed data grid. A distributed data grid is a system in which a collection of computer servers work together in one or more clusters to manage information and related operations, such as computations, within a distributed or clustered environment. A distributed data grid can be used to manage application objects and data that are shared across the servers. A distributed data grid provides low response time, high throughput, predictable scalability, continuous availability, and information reliability. In particular examples, distributed data grids, such as, e.g., the “Oracle Coherence” data grid from Oracle Corp., store information in-memory to achieve higher performance, and employ redundancy in keeping copies of that information synchronized across multiple servers, thus ensuring resiliency of the system and continued availability of the data in the event of failure of a server.

In one embodiment, system 10 is a computing/data processing system including an application or collection of distributed applications for enterprise organizations, and may also implement logistics, manufacturing, and inventory management functionality. The applications and computing system 10 may be configured to operate with or be implemented as a cloud-based system, a software-as-a-service (“SaaS”) architecture, or other type of computing solution.

In general, with known solutions, the capabilities of machine learning (“ML”) and AI have been exploited in relatively isolated and specialized domains, for very localized use cases and for separated different formats of data. However, text, audio, pictures and video data are being generated in immense volumes and speed every day, either on-demand or in live streaming.

In contrast, embodiments are directed to a cloud based, fully integrated and human like cognitive service, able to analyze and enrich those contents, which can open the doors for solving innumerable challenges of using machines and unfold the power of interaction between human and machines. Embodiments unify disparate AI and ML solutions to ultimately resemble the real ways the human brain works (i.e., by considering all kinds of inputs in parallel and understanding the context it is exposed to as a whole).

Referring again to FIG. 1, system 150 includes an AI cognitive cloud service module 140 that the cloud-based AI service available via API calls. Module 150 provides an integrated cognitive analysis of text, image, audio and video files, input on demand, as well as in streams. An integration module 140 provides for the automatic format detection and forwarding to relevant satellites service modules 130-139 and the orchestration of satellite service modules 130-139 that perform the functionality of (1) speech to text translation; (2) language recognition and translation; (3) topic and sentiment analysis; (4) object detection, recognition and classification; (4) text to speech translation; (5) read texts on pictures or scenes; (6) entity recognition, classification and anonymization (i.e. entity filtering); (7) scene description via natural-language generation (“NLG”) made on what is happening in the scenes; and (8) content search based on semantic and syntactic queries. The output of module 140 is a comprehensive audiovisual material, where an enriched, human-like summary of the input content 100 is automatically produced.

The satellite service modules 130-139 provide data processing and data transformation using trained AI and ML models. Each of modules 130-139 are implemented with state of the art ML and AI models required for all the functionalities of the service. Embodiments collect enough data relevant to train (and regularly re-train) the collected models. Embodiments serialize the trained models in an efficient format, in order to used them for producing predictions close to real time. Model serialization is performed in embodiments by writing objects (within the “object oriented programming” context) into a byte-stream, which can be stored onto a non-volatile computer memory device. Once stored, this file can be read at any later point in time, thus retrieving the stored objects to reuse them in new programming routines or algorithms. Standard methods for model serialization in ML and AI include, for example, “pickle”, “joblib”, “hdf5” for the Python language or “POJO”, “MOJO” for the Java language.

Embodiments embed the whole model training and prediction into a continuous integration (“CI”) and continuous delivery (“CD”) framework, in order to allow for a continuous development and release cycle of the service version. Embodiments embed the whole model training and prediction into an infrastructure as code (“IaC”) framework, in order to efficiently manage the hardware and software resources for training the models and offering predictions close to real time.

An entity recognizer 131 provides entity recognition, classification and anonymization. Named-entity recognition (“NER”) (also known as named entity identification, entity chunking, and entity extraction) is a subtask of information extraction that seeks to locate and classify named entities, e.g. mentioned in unstructured text, into pre-defined categories such as person names, organizations/institutions, locations, time expressions, quantities, monetary values, percentages, medical codes, etc.

NER generally entails identifying names (one or more words) in text and assigning them a type (e.g., person, location, organization). State-of-the-art supervised approaches use statistical models that incorporate a name's form, its linguistic context, and its compatibility with known names. These models are typically trained using supervised machine learning and rely on large collections of text where each name has been manually annotated, specifying the word span and named entity type.

A language recognizer 132 provides language recognition and translation. In natural language processing, language identification or language guessing is the process of determining which natural language the given content is in. Computational approaches to this problem view it as a special case of text categorization, solved with various statistical methods.

Embodiments can use several statistical approaches to language identification using different techniques to classify the data. One technique is to compare the compressibility of the text to the compressibility of texts in a set of known languages. This approach is known as mutual information based distance measure. The same technique can also be used to empirically construct family trees of languages which closely correspond to the trees constructed using historical methods. Mutual information based distance measure is essentially equivalent to more conventional model-based methods.

Another technique is to create a language n-gram model from a “training text” for each of the languages. These models can be based on characters or encoded bytes. In the latter, language identification and character encoding detection are integrated. Then, for any piece of text needing to be identified, a similar model is made, and that model is compared to each stored language model. The most likely language is the one with the model that is most similar to the model from the text needing to be identified. This approach can be problematic when the input text is in a language for which there is no model. In that case, the method may return another, “most similar” language as its result.

An optical character recognizer 133 provides optical character recognition (“OCR”). OCR is the electronic or mechanical conversion of images of typed, handwritten or printed text into machine-encoded text, whether from a scanned document, a photo of a document, a scene-photo (e.g., the text on signs and billboards in a landscape photo) or from subtitle text superimposed on an image (e.g., from a television broadcast).

Embodiments can use two different types of OCR algorithms which may produce a ranked list of candidate characters. Specifically, matrix matching involves comparing an image to a stored glyph on a pixel-by-pixel basis. It is also known as “pattern matching”, “pattern recognition”, or “image correlation”. This relies on the input glyph being correctly isolated from the rest of the image, and on the stored glyph being in a similar font and at the same scale. This technique works best with typewritten text and does not work well when new fonts are encountered.

Feature extraction decomposes glyphs into “features” such as lines, closed loops, line direction, and line intersections. The extraction features reduces the dimensionality of the representation and makes the recognition process computationally efficient. These features are compared with an abstract vector-like representation of a character, which might reduce to one or more glyph prototypes. Nearest neighbor classifiers such as the k-nearest neighbors algorithm are used to compare image features with stored glyph features and choose the nearest match.

An optical recognizer 134 provides object detection. Object detection is a technology related to computer vision and image processing that deals with detecting instances of semantic objects of a certain class, such as humans, buildings, cars, etc., in digital images and videos. Well-researched domains of object detection include face detection and pedestrian detection. Object detection has applications in many areas of computer vision, including image retrieval and video surveillance.

Embodiments can implement object detection either using neural network-based or non-neural approaches. For non-neural approaches, it becomes necessary to first define features and then using a technique such as support vector machine (“SVM”) to do the classification. On the other hand, neural techniques are able to do end-to-end object detection without specifically defining features, and can be based on convolutional neural networks (“CNN”).

A speech to text converter 135 provides speech recognition. Speech recognition is an interdisciplinary subfield of computer science and computational linguistics that develops methodologies and technologies that enable the recognition and translation of spoken language into text by computers. It is also known as automatic speech recognition, computer speech recognition or speech to text. It incorporates knowledge and research in the computer science, linguistics, statistical learning and software engineering fields.

One embodiment uses Hidden Markov Models (“HMM”) for the speech recognition. These are statistical models that output a sequence of symbols or quantities. HMMs are used in speech recognition because a speech signal can be viewed as a piecewise stationary signal or a short-time stationary signal. In a short time-scale (e.g., 10 milliseconds), speech can be approximated as a stationary process. Speech can be thought of as a Markov model for many stochastic purposes. Further, HMMs can be trained automatically and are simple and computationally feasible to use. In speech recognition, the hidden Markov model would output a sequence of n-dimensional real-valued vectors (with n being a small integer, such as 10), outputting one of these every 10 milliseconds. The vectors would consist of cepstral coefficients, which are obtained by taking a Fourier transform of a short time window of speech and decorrelating the spectrum using a cosine transform, then taking the first (most significant) coefficients. The hidden Markov model will tend to have in each state a statistical distribution that is a mixture of diagonal covariance Gaussians, which will give a likelihood for each observed vector. Each word, or (for more general speech recognition systems), each phoneme, will have a different output distribution; a hidden Markov model for a sequence of words or phonemes is made by concatenating the individual trained hidden Markov models for the separate words and phonemes.

A syntax parsing based search engine 136 provides information retrieval. An information retrieval query language is used to make queries for searching on indexed content. A query language is formally defined in a context-free grammar and can be used by users in a textual, visual/UI or speech form. Advanced query languages are often defined for professional users in vertical search engines, so they get more control over the formulation of queries. For instance, natural query language supporting human-like querying by parsing the natural language query to a form that can be best used to retrieve relevant contents inside documents, for example with question-answering systems or conversational search.

Syntax parser 136 in embodiments that takes input data (frequently text) and builds a data structure—often some kind of parse tree, abstract syntax tree or other hierarchical structure, giving a structural representation of the input while checking for correct syntax. The parsing may be preceded or followed by other steps, or these may be combined into a single step. The parser is often preceded by a separate lexical analyzer, which creates tokens from the sequence of input characters; alternatively, these can be combined in scannerless parsing. Parsers may be programmed by hand or may be automatically or semi-automatically generated by a parser generator. Parsing is complementary to templating, which produces formatted output. These may be applied to different domains, but often appear together, such as the scanf/printf pair, or the input (front end parsing) and output (back end code generation) stages of a compiler.

The input to a parser is often text in some computer language, but may also be text in a natural language or less structured textual data, in which case generally only certain parts of the text are extracted, rather than a parse tree being constructed. Parsers range from very simple functions such as scanf, to complex programs such as the frontend of a C++ compiler or the HTML parser of a web browser. An important class of simple parsing is done using regular expressions, in which a group of regular expressions defines a regular language and a regular expression engine automatically generating a parser for that language, allowing pattern matching and extraction of text. In other contexts regular expressions are instead used prior to parsing, as the lexing step whose output is then used by the parser.

A natural language generator 137 provides NLG. NLG is a software-based process that produces natural language output. Common applications of NLG methods include the production of various reports, for example weather and patient reports, image captions, landscape description and chatbots. Automated NLG can be compared to the process that humans use when they turn ideas into writing or speech. Psycholinguists prefer the term language production for this process, which can also be described in mathematical terms, or modeled in a computer for psychological research. In embodiments, natural language generation uses character-based recurrent neural networks with finite-state prior knowledge.

Text to speech converter 138 provides text to speech conversion. Speech synthesis is the artificial production of human speech. A computer system used for this purpose is called a speech computer or speech synthesizer. It can be implemented in software and/or hardware products. A text-to-speech (“TTS”) system converts normal language text into speech. Other systems render symbolic linguistic representations like phonetic transcriptions into speech.

Synthesized speech can be created by concatenating pieces of recorded speech that are stored in a database. Systems differ in the size of the stored speech units; a system that stores phones or diphones provides the largest output range, but may lack clarity. For specific usage domains, the storage of entire words or sentences allows for high-quality output. Alternatively, a synthesizer can incorporate a model of the vocal tract and other human voice characteristics to create a completely “synthetic” voice output.

A topic and sentiment analyzer 139 provides sentiment extraction. In ML and NLP, a topic model is a type of statistical model for discovering the abstract “topics” occurring in a collection of documents. Topic modeling is a frequently used text-mining tool for discovery of hidden semantic structures in a text body. Intuitively, given that a document is about a particular topic, one expects that particular words appear in the document more or less frequently. A document typically concerns multiple topics in different proportions. The “topics” produced by topic modeling techniques are clusters of similar words, captured in a mathematical framework allowing examination and discovery, based on the statistics of the words in the whole text corpus.

Sentiment analysis (i.e., opinion mining or emotion AI) is the use of NLP, text analysis, computational linguistics and biometrics to systematically identify, extract, quantify, and study affective states and subjective information. It is widely applied to people's feedbacks such as reviews, survey responses, online and social media, marketing campaigns, etc.

In one embodiment, topic and sentiment analyzer 139 generates sentiment analysis and generates a corresponding polarity score. For example, if the polarity is >0, the sentiment of the input text is considered positive, <0 is considered negative, and =0 is considered neutral. In one embodiment, an artificial neural network or other type of artificial intelligence is used for the semantic analysis of 139 as disclosed, for example, in U.S. Pat. Pub. Nos. 2020/0394478. In this embodiment, a word embedding model including a first plurality of features is generated. A value indicating sentiment for the words in the first data set can be determined using a convolutional neural network (“CNN”). A second plurality of features are generated based on bigrams identified in the data set. The bigrams can be generated using a co- occurrence graph. The model is updated to include the second plurality of features, and sentiment analysis can be performed on a second data set using the updated model. In other embodiments, other techniques for using a neural network for semantic analysis and polarity assignment, such as disclosed in U.S. Pat. Pub. Nos. 2017/0249389 and 2020/0286000, are implemented.

In one embodiment, each of modules 130-139 are implemented by a separately trained neural network. The training of the neural network from a given example is conducted by determining the difference between the processed output of the network (often a prediction) and a target output, which is the “error”. The network then adjusts its weighted associations according to a learning rule and using this error value. Successive adjustments cause the neural network to produce output which is increasingly similar to the target output. After a sufficient number of these adjustments the training is terminated based upon certain criteria, known as “supervised learning.”

System 150 further includes a cloud API input 111 that provides an input to module 140. In one embodiment, API input 111 is a representational state transfer (“REST”) API service, able to receive a request with a header and a payload. The header and payload are used for specifying usage options of the service, as well as the audiovisual content to be analyzed by the central component. The endpoint of this API resides on cloud 110. API 111 interacts with several standard programming languages for machines, websites and mobile applications (e.g., JAVA, Python, Scala, Ruby, Go, etc.).

System 150 further includes a cloud API output 112 that provides an API output. In one embodiment, API output 112 is a REST API service able to return requests containing a service response. The service response includes metadata from the initial request and the performed calculation itself, as well as the comprehensive audiovisual file resulting from the analysis of the central component.

APIs 111, 112 in embodiments can be accessed and queried via HTTPS requests, offering the cognitive service in a standard and universally integrable manner.

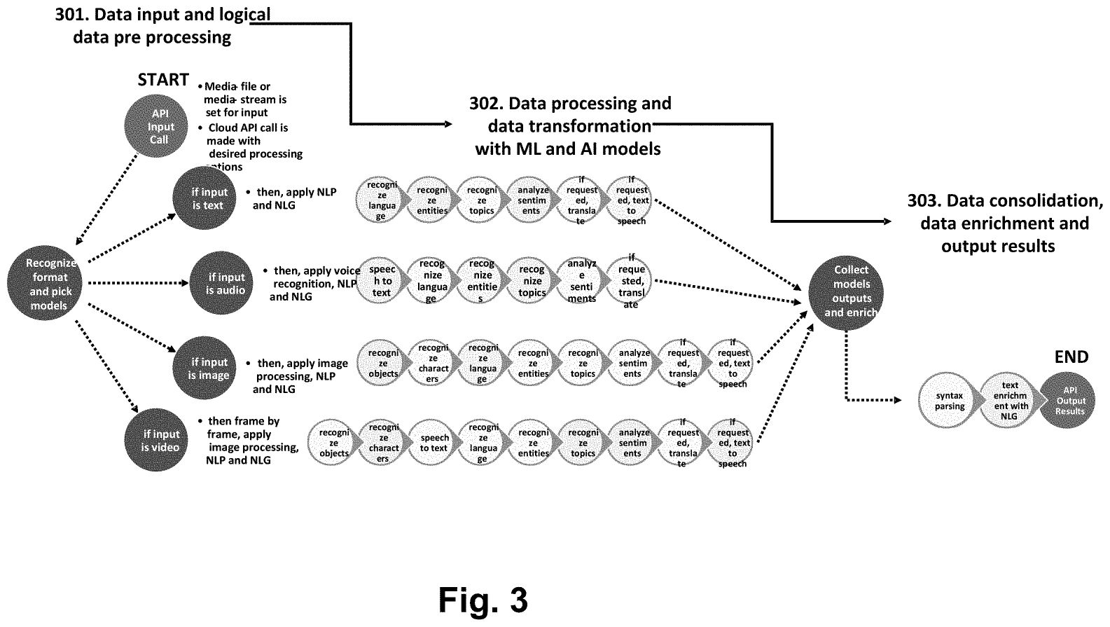

FIG. 3 is a high level diagram of the functionality of system 150 of FIG. 1 in accordance to embodiments. As shown in FIG. 3, at 301, AI cognitive cloud service module 140 performs data input using data 100 and logical data pre-processing. At 302, one or more of modules 130-139 perform data processing and data transformation using ML and AI models. At 303, AI cognitive cloud service module 140 performs data consolidation and data enrichment and outputs the results 120.

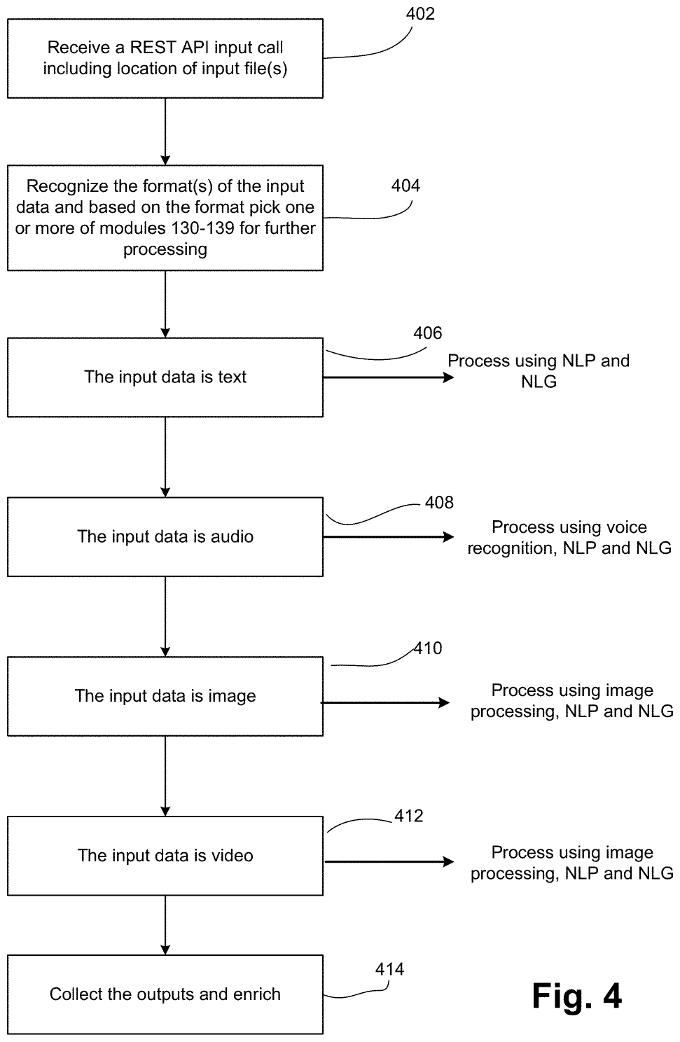

FIG. 4 is a flow diagram of the functionality of AI cognitive cloud service module 140 of FIG. 1 for performing AI cognitive cloud services in accordance with one embodiment. In one embodiment, the functionality of the flow diagram of FIG. 4 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 402, module 150 receives a REST API input call 111. API input call 111 in embodiments include the following API parameters:
username: Registered name of user.
password: User's authentication passphrase.
input_uri: Location of input file, e.g. local, web, streaming endpoint, etc.
translate_to: If translation into another language is required.
text_to_speech: If output should include audio from found text.
output_uri: Location of output like input_uri.
other_options: Another desired processing parameters.

The following pseudo-code is an example of API input call 111:

```
import oracle_cognitive_service as ocg;
my_session = ocg.session(username = “john_doe”, password = “mY-53cr3t5”
my_request = my_session(
  input_uri = {
    “path_from_input_file”,
    “input_url”,
    “other_service_endpoint”
  )
  translate_to = {“en”, “de”, “es”, “fr”, “it”, “nl”, “jp”, “ch”, . . .},
  text_to_speech = {“no”, “yes”},
  output_uri = {
    “path_to_output_file”,
    “output_url”,
    “other_service_endpoint”
  },
  other_options = {“value_1”, “value_2”, . . .}
};
my_request.send();
my_request.get_result;
  * Strings inside keys are mutually exclusive possible option values! *
```

The input content to be analyzed by module 140 can be provided in different formats (e.g., .txt, .doc, .pdf, etc.; jpeg, .png, .gif, etc.; mp3, mp4, .avi, .mpeg, .webm, etc.). The input can be provided from a local data source or streamed on-demand or live.

At 404, module 140 recognizes the format(s) of the input data and based on the format picks one or more of modules 130-139 for further processing based on the input data and the content of the REST API. Format recognition in one embodiment is performed by analyzing the metadata of any file or data transfer protocol. For example, a given file extension found in the file metadata determines the format of the content. Based on industry standards, it is possible to identify if a file is audio (*.mp3, *.wav, *.ogg, *.wav, *.wma, *.m4p, etc.), or video (*.avi, *.wmv, *.webm, *.mov, *. mp4, etc.), or image (*.tiff, *.gif, *.png, *.jpeg, *.bmp, etc.) or text (*.txt, *.doc, *.rtf, etc.). With this mechanism, module 140 categorizes the given input and passes it to the further applicable content processing modules.

At 406, if the input data is text, NLP and NLG is applied using modules 130-139. The AI based functionality applied by modules 130-139 includes: (1) recognize the language; (2) recognize entities; (3) recognize topics; (4) analyze sentiments; (5) if requested, provide language translation; (6) if requested, perform text to speech conversion.

At 408, if the input data is audio, voice recognition, NLP and NLG is applied using modules 130-139. The AI based functionality applied by modules 130-139 includes: (1) speech to text; (2) recognize the language; (3) recognize entities; (4) recognize topics; (5) analyze sentiments; (6) if requested, provide language translation.

At 410, if the input data is image, image processing, NLP and NLG is applied using modules 130-139. The AI based functionality applied by modules 130-139 includes: (1) recognize objects; (2) recognize characters; (3) recognize language; (4) recognize entities; (5) recognize topics; (6) analyze sentiments; (7) if requested, provide language translation; (8) if requested, perform text to speech conversion.

At 412, if the input data is video, on a frame by frame basis, image processing, NLP and NLG is applied using modules 130-139. The AI based functionality applied by modules 130-139 includes: (1) recognize objects; (2) recognize characters; (3) speech to text conversion; (4) recognize language; (5) recognize entities; (6) recognize topics; (7) analyze sentiments; (8) if requested, provide language translation; (9) if requested, perform text to speech conversion.

At 414, module 140 collects the output from each of the models of modules 130-139 and enriches the outputs with natural language. The enriching includes syntax parsing, and text enrichment with NLG. The result is then output via API output 112. In embodiments, the enrichment includes applying automatic text summarization, which is the process of producing a machine-generated, concise and meaningful summary of text from multiple text resources such as books, news articles, blog posts, research papers, emails, tweets, etc. In embodiments, the text resources are the ones being previously generated by all other modules 130-139, except module 137, which covers the NLG tasks as discussed above.

The output 112 is provided by request against a user authenticated session of the REST API. The resulting output is a set of standard file formats combining all results (i.e., .json with results metadata, .text with summarized analysis, (e.g., text transcriptions of speeches), .mp3 with speech from the .text if specified in options).

### Use Cases

One example use case involves a brand positioning study for brand XYZ based on openly posted videos. Company XYZ, which exhibits a widely known market branding, is very interested on keeping and improving its public image. System 150 is to be used to provide answers to the following questions: (1) Are customers and consumers from the brand XYZ satisfied with the products and services? (2) How is XYZ positioned in comparison to competitors? (3) What are the most relevant public opinions about XYZ? (4) Which are the segments of people reached by the brand XYZ?

Input into system 150 are thousands of openly accessible videos where the brand XYZ is mentioned. System 150 then performs a holistic analysis of all the videos and produce a complete summary of what is mentioned in relation to the brand XYZ and in with which kind of opinion. Modules 130-139 (except module 137) analyze the video extracting many specific details such as which objects are on the scenes, which text, what is said during the video, which entities are mentioned (e.g., other brands), which sentiments are being expressed, etc. Module 140 collects all those outcomes and reroutes them into module 137 which then generates an automatic summary using NLG techniques, which provides a holistic text expressing what people are saying, doing and feeling about brand XYZ.

Another example use case is an automated summary of worldwide sport events for a television channel which offers sport news on-demand via a website and a mobile app. System 150 is used to determine how to efficiently manage the content generation and publishing for the highlights and summaries of hundreds of sport events taking place every weekend.

Embodiments provide an automated, machine based report generation, made possible by system 150. Sport, cultural, social and political events, weather predictions, news, trending topics, are happening everywhere with accelerating pace. The day is overflowed with content and information. Processing it manually has become unmanageable. The holistic, audiovisual analysis offered by system 150 can help to mitigate the spreading of negatively, locally biased social media content. By analyzing the content from many different sources in a machine based manner, more sources, from different locations, languages and tendencies can be merged together to provide a balanced, more objective overview. Modules 130-139 (except module 137) gather all specific aspects from those different sources and provide them via module 140 into module 137. At module 137, a summary is generated, where all angles and perspectives are weighted and imprinted into a short text. In this final text, the wide spectrum is shown, instead of a single, strongly biased content. The principle of “the wisdom of the crowd”, which is one of the foundations of democracy, is thus here applied, by democratizing the content of information.

Another example use case is automatically digitizing old registry documents stored in analog formats for a public office needing to deal with registry data collected in the many decades before the new digital technologies arrived. In order to process any request of service made by citizens, companies and other institutions, the public administration need to double check data stored in analogical form in their registry. This process is manual, time and resource consuming and even unreliable. An efficient solution is absolutely necessary.

The majority of newly generated information is already made available in digital form. However, not all, and even all data collected until 10 to 15 years ago resides in analog format, which system 150 can extract and process automatically to adapt it to the new digital formats. After, for example, taking pictures, scanning or even videos of different old documents and sources of information, which remain stored in their analog format, these pictures, scans and videos can be processed with module 140. It will activate and pass the data through the different applicable modules 130-139 (except module 137). In that sense, a holistic, machine-generated digital format of all those old sources can be produced and stored for a non-invasive and modern way of analysis. Examples include old manuscripts and art pieces from museums (a vast amount of them remain uncategorized), old civil registries (properties, infrastructure, population, environmental, etc.), old library sources, old legal registry (old court cases and decisions, laws valid since long ago) and so on.

Another example use case is infrastructure planning based on information enriching from unstructured data for a regional government which needs to implement a sustainable development planning according to current population needs. Approximately 20% of the data being collected is structured, such as census data, infrastructure databases, etc. However, 80% of the collected data is unstructured, such as aerial pictures of traffic, residential and green areas, public office reports, news. There is a need to enrich the existent structure data to fill the gaps of real need in the sustainable development of the region.

System 150 can provide the processing, images, videos, text reports, local news as audio and video, etc., that can complete the picture of what are the real pain points of the current infrastructure. With system 150, structured data can be extracted from all those input media to measure the real needs for a future sustainable infrastructure. Typical data about infrastructure of a city is stored in charts, plans and documents with a static point of view. Recent and actual data coming from aerial pictures for instance, can be processed by modules 130-139 (except module 137) in order to, for example, recognize and quantify green areas, peoples flux, traffic flux, night illumination gaps, etc. Embodiments apply well established object and entity recognition techniques. Module 137 can then summarize the current actual situation and even describe its evolution over a given period of time. This will substantially enrich the structure static data already existing in the public registries of city infrastructure.

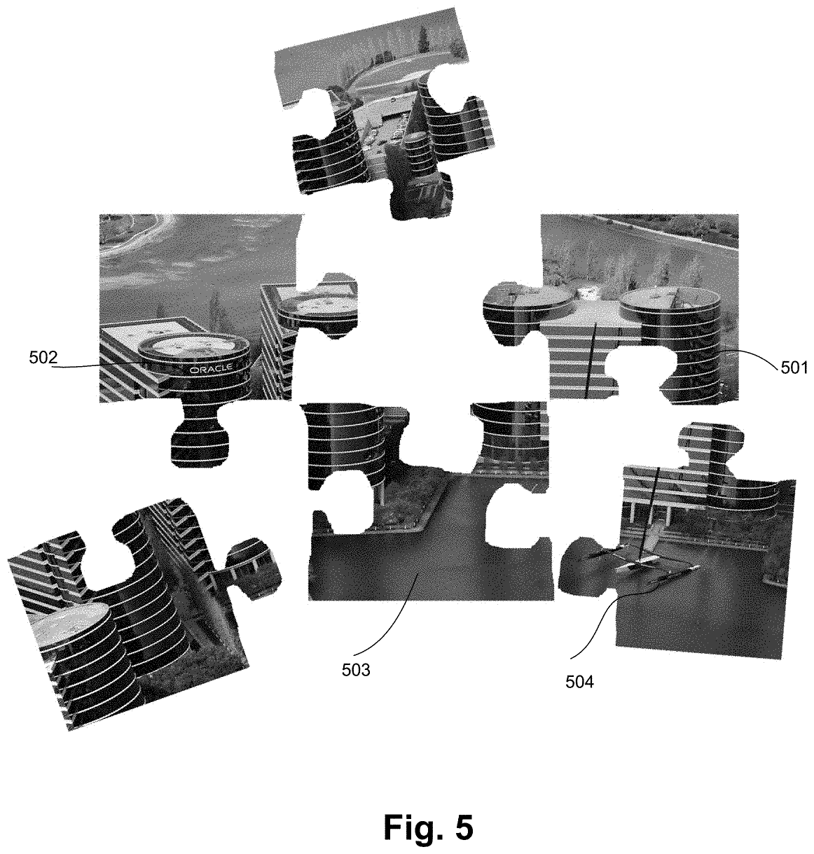

Embodiments, by implementing a holistic analysis approach using a technological solution of combining multiple models 130-139, can provide results that cannot be provided merely by combining individual components. FIG. 5 illustrates an example input to demonstrate unexpected results of embodiments of the invention. FIG. 5 illustrates the following elements of an image: (1) buildings with cylindrical shape (501); (2) the word ORACLE (502); (3) a lake (503); and (4) a regatta boat (504).

In contrast to individual models, system 150 can determine, using FIG. 5 as an input, that it is a picture of the Californian headquarters from ORACLE, a global software, hardware and IT services US company, which also competes in regatta yacht racings. Specifically, embodiments uses modules 130-139 (except module 137) for recognizing objects, writings and even entities such as companies or locations. Once this basic information is given back to module 140, it reroutes that to module 137 where all pieces are put together via automatic summarizing. Module 137 can for instance connect to sources of general knowledge for enriching the summary with references such as Wikipedia, Scholarpedia, etc. Similar to a chatbot, module 140 can receive the input picture with the implicit answer, what is on that picture. Any known approach will merely list independent, unlinked objects or facts. In contrast, module 140 will be able to provide a more natural answer to what is there, by combining and linking all those elements on the picture into a single holistic description.

As disclosed, embodiments integrate all selected models in a higher level intelligence management algorithm, which orchestrates the combination of all specialized ML and AI algorithms to provide robust and self-consistent predictions out of input data in different formats. Based on all data processed, measured, analyzed and summarized, embodiments can be used, for example, to provide output as if a human were describing what he/she feels, when seeing a video of a beautiful natural landscape with sounds of birds singing or water from a stream is running.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of providing cognitive cloud services comprising:
receiving, via an input Application Programming Interface (API), input data, the input data comprising one or more of text data, picture data, audio data and video data;
determining one or more formats of the input data;
based on the determined formats, selecting one or more of artificial intelligence based modules for processing of the input data;
collecting an output resulting from the processing of the input data;
enriching the output; and
providing the enriched output via an output API.

2. The method of claim 1, wherein the determining the formats of the input data comprises analyzing metadata corresponding to the input data, further comprising based on a payload of the API and the determined formats, selecting functionality performed by the artificial intelligence based modules.

3. The method claim 1, the enriching comprising text enriching using a natural language generator.

4. The method of claim 1, the artificial intelligence based modules comprising trained models that each perform one of: speech to text translation; language recognition and translation; topic and sentiment analysis; object detection, recognition and classification; text to speech translation; reading texts on pictures or scenes; entity recognition, classification and anonymization; scene description via natural-language generation; or content search based on semantic and syntactic queries.

5. The method of claim 4, further comprising serializing the trained models.

6. The method of claim 1, wherein the input data comprises video data and the enriched output comprises a summary of the video data.

7. The method of claim 1, wherein the input API comprises a representational state transfer (REST) API comprising a header and payload and having an endpoint that resides on the cloud.

8. An artificial intelligence cognitive cloud system comprising:
an input Application Programming Interface (API) configured to receive input data, the input data comprising one or more of text data, picture data, audio data and video data;
one or more processors configured to:
determine one or more formats of the input data;
based on the determined formats, selecting one or more of artificial intelligence based modules for processing of the input data;
collecting an output resulting from the processing of the input data;
enriching the output; and
providing the enriched output via an output API.

9. The system of claim 8, wherein the determining the formats of the input data comprises analyzing metadata corresponding to the input data, further comprising based on a payload of the API and the determined formats, selecting functionality performed by the artificial intelligence based modules.

10. The system of claim 8, the enriching comprising text enriching using a natural language generator.

11. The system of claim 8, the artificial intelligence based modules comprising trained models that each perform one of: speech to text translation; language recognition and translation; topic and sentiment analysis; object detection, recognition and classification; text to speech translation; reading texts on pictures or scenes; entity recognition, classification and anonymization; scene description via natural-language generation; or content search based on semantic and syntactic queries.

12. The system of claim 11, the processors further configured to serializing the trained models.

13. The system of claim 8, wherein the input data comprises video data and the enriched output comprises a summary of the video data.

14. The system of claim 8, wherein the input API comprises a representational state transfer (REST) API comprising a header and payload and having an endpoint that resides on the cloud.

15. A computer-readable medium storing instructions which, when executed by at least one of a plurality of processors, cause the processors to provide cognitive cloud services, the providing comprising:
receiving, via an input Application Programming Interface (API), input data, the input data comprising one or more of text data, picture data, audio data and video data;
determining one or more formats of the input data;
based on the determined formats, selecting one or more of artificial intelligence based modules for processing of the input data;
collecting an output resulting from the processing of the input data;
enriching the output; and
providing the enriched output via an output API.

16. The computer-readable medium of claim 15, wherein the determining the formats of the input data comprises analyzing metadata corresponding to the input data, further comprising based on a payload of the API and the determined formats, selecting functionality performed by the artificial intelligence based modules.

17. The computer-readable medium of claim 15, the enriching comprising text enriching using a natural language generator.

18. The computer-readable medium of claim 15, the artificial intelligence based modules comprising trained models that each perform one of: speech to text translation; language recognition and translation; topic and sentiment analysis; object detection, recognition and classification; text to speech translation; reading texts on pictures or scenes; entity recognition, classification and anonymization; scene description via natural-language generation; or content search based on semantic and syntactic queries.

19. The computer-readable medium of claim 18, the providing further comprising serializing the trained models.

20. The computer-readable medium of claim 15, wherein the input data comprises video data and the enriched output comprises a summary of the video data.
